(19) United States
(12) Patent Application Publication
(10) Pub. No.: US 2024/0169310 A1
(43) Pub. Date: May 23, 2024

(54) Technologies for Analyzing Statistics Among Geographic Regions to Assess Shipping Information

(71) Applicant: PROJECT44, LLC, Chicago, IL (US)

(72) Inventors: Thomas Janos Atwood, San Francisco, CA (US); Milad Davaloo, Oakland, CA (US)

(21) Appl. No.: 17/990,287

(22) Filed: Nov. 18, 2022

(51) Int. Cl. G06Q 10/08

(52) U.S. Cl. CPC G06Q 10/0838

(57) ABSTRACT

Systems and methods for analyzing statistics among geographic regions to assess shipping information are disclosed herein. An example method includes receiving an origin and a destination from an electronic device associated with a user, and determining an origin tile representative of a first geographic area that includes the origin and a destination tile representative of a second geographic area that includes the destination. The example method further includes automatically determining a first region surrounding the origin tile and a second region surrounding the destination tile. The example method further includes aggregating shipping information corresponding to shipments delivered between the first region and the second region, and calculating one or more shipping metrics based on the shipping information. The example method further includes rendering, on a user interface, the one or more shipping metrics for access by the electronic device.

### BACKGROUND

When shipping goods, consumers typically desire to use a shipping provider that will deliver the goods to the correct location, on-time, and in pristine condition. Determining which shipping provider may satisfy those requirements for any given shipment can be complicated, as each shipping provider may service different regions and employ a variety of transportation personnel that each drive in different manners (e.g., exercise more or less caution). As such, development of technologies that can reliably provide relevant logistics data for shipping providers is a topic of great interest in the field of shipping/data logistics.

However, conventional shipping logistics technologies suffer from several drawbacks that prevent them from providing such reliable and relevant logistics data. As an example, conventional shipping logistics technologies require a pre-defined, rigid definition of a “lane” when filtering logistics data, resulting in irrelevant, rigid results. The most common such definition is between an origin zip code and a destination zip code, but this definition does not provide much relevant information for points near a region boundary, nor does it allow for expansion or contraction of the region based on the consumer's specific use-case. Consequently, conventional shipping logistics technologies suffer from numerous issues that minimize the flexibility of the system to provide relevant results, produce unwanted edge artifacts based on rigid definitions, and create an unsavory user experience.

Thus, there is a need for technologies for analyzing statistics among geographic regions to assess shipping information that enables a system to provide a user with reliable, relevant shipping logistics data in an efficient, consistent manner.

### SUMMARY

As previously mentioned, conventional shipping logistics technologies suffer from a general lack of flexibility and relevancy, such that users often receive shipping logistics data (also referenced herein as “shipping metrics”) that fails to provide them with the information necessary to determine which shipping provider to use. Many of these issues are the result of a rigid lane definition, through which, conventional shipping logistics providers retrieve/filter shipping logistics data. For example, a conventional shipping logistics provider may search for logistics data using a lane defined only by a geographically clustered group of zip codes near the origin and the destination. This configuration leverages the most common definition of a lane, but suffers from numerous drawbacks. For example, the resulting search may lack flexibility to identify relevant data that may exist just outside and/or otherwise nearby the defined cluster of zip codes. This definition may also suffer from edge artifacts, as data representing an entire zip code (or multiple) may not accurately represent a location that falls on the edge of such a region. This definition also generally lacks universal applicability/scalability (e.g., regions that do not use zip codes), and can produce overlapping/interleaving results, such that a user may find the data returned on the basis of such a lane definition duplicitous, if not completely irrelevant. Moreover, other conventional approaches attempt to calculate all data in real-time, which routinely overwhelms processing resources to such a severe extent that users are generally unable to receive any results in a reasonable timeframe. Thus, in general, conventional shipping logistics technologies are incapable of consistently providing relevant, timely shipping logistics data for users.

Therefore, it is an objective of the present disclosure to eliminate these and other problems with conventional shipping logistics technologies by introducing a dynamic lane aggregation algorithm that enables users to dynamically define lanes; and as a result, consistently provides users with relevant shipping metrics based on aggregated shipping information. In particular, the dynamic lane aggregation algorithm of the present disclosure alleviates the issues present with conventional technologies by defining a lane based on automatically determined tiles and regions surrounding the tiles from an origin and destination received from a user. Such a dynamically defined lane enables the lane aggregation algorithm to intelligently and efficiently aggregate shipping information corresponding to shipments delivered along the lane. The algorithm subsequently calculates shipping metrics from the aggregated shipping information in order to present the user with relevant data that may allow the user to make an informed decision regarding a preferred shipping provider.

In accordance with the above, and with the disclosure herein, the present disclosure includes improvements in computer functionality or in improvements to other technologies at least because the present disclosure describes that, e.g., shipping logistics systems, and their related various components, may be improved or enhanced with the disclosed dynamic lane aggregation algorithm that provides more efficient and relevant shipping metrics for respective users. That is, the present disclosure describes improvements in the functioning of a shipping logistics system itself or “any other technology or technical field” (e.g., the field of shipping/data logistics) because the disclosed dynamic lane aggregation algorithm improves and enhances operation of shipping logistics systems by introducing improved lane definition flexibility/accuracy along with reduced shipping information aggregation data times to eliminate numerous inefficiencies and shipping metric irrelevancies typically experienced by shipping logistics systems lacking such a dynamic lane aggregation algorithm. This improves over the prior art at least because such previous shipping logistics systems were inaccurate and inefficient as they lack the ability to flexibly/dynamically define lanes in a manner that allows for efficient retrieval or interpretation of shipping information.

In particular, the dynamic lane aggregation algorithm improves lane definition flexibility/accuracy by defining lanes based, in part, on tiles that may include a plurality of pre-computed shipping metrics for various carriers that completed and/or otherwise performed trips/deliveries corresponding to the tiles. For example, tiles that are geographically relevant (e.g., proximate) to the identified origin/destination tiles may be included in the shipping metrics calculations/aggregations performed by the dynamic lane aggregation algorithm, whereas tiles that are not geographically relevant (e.g., are not proximate) may be excluded from the shipping metrics calculations/aggregations to avoid skewing and/or otherwise erroneously influencing the resulting shipping metrics. Consequently, the algorithm of the present disclosure improves the accuracy of lane definitions and the resulting shipping metrics when compared with conventional techniques by eliminating features such as edge artifacts and other irrelevant and/or otherwise undesirable shipping metrics that are included in the metrics generated by conventional techniques.

Additionally, the lane definition described in the present disclosure improves over conventional systems by being scalable/applicable in any region of the world. Conventional systems are bound to a singular and/or otherwise rigid definition regarding the geographic areas available for lane definitions (e.g., states, provinces, territories, etc.). As a result, these conventional systems lack the flexibility to define relevant lanes in geographic regions of the world that do not conform to the pre-defined, rigid lane definition. The dynamic lane aggregation algorithm of the present disclosure categorizes all regions of the world uniformly based on sets of tiles, such that any country or other region of the world is defined similarly to any other country or region of the world. Thus, the dynamic lane aggregation algorithm dramatically increases the flexibility of lane definitions over conventional systems by applying a tile-based geographic categorization system that is independent of any country/region's specific conventions.

Moreover, the dynamic lane aggregation algorithm of the present disclosure reduces shipping information aggregation data times as compared to conventional techniques by determining which shipping metrics to actively calculate and which shipping metrics to retrieve from pre-computed tables. The techniques of the present disclosure also enable storage of pre-computed metrics for aggregations of tiles grouped in various manners (e.g., individual tiles, groups of tiles corresponding to a city, etc.), such that calculating shipping metrics for any region may involve immediate aggregation of the pre-computed statistics over at least a portion of the region, and the remaining portion of the region may be actively calculated. Such active determination and shipping metrics storage reduces the demand on local/remote processing resources by intelligently eliminating duplicitous calculations for regions that have pre-computed statistics, and thereby also causes the systems of the present invention to calculate the shipping metrics quicker than conventional techniques by reducing the amount of calculations that are required for any given region.

In addition, the present disclosure includes applying various features and functionality, as described herein, with, or by use of, a particular machine, e.g., a central logistics server, a user device, a shipping provider device, and/or other hardware components as described herein.

Moreover, the present disclosure includes specific features other than what is well-understood, routine, conventional activity in the field, or adding unconventional steps that demonstrate, in various embodiments, particular useful applications, e.g., determining, by the one or more processors, an origin tile based on the origin and a destination tile based on the destination; automatically determining, by the one or more processors, a first region surrounding the origin tile and a second region surrounding the destination tile; and aggregating, by the one or more processors, shipping information corresponding to shipments delivered between the first region and the second region.

In an embodiment, the present invention is a method for analyzing statistics among geographic regions to assess shipping information. The method may include: receiving, at one or more processors, an origin and a destination from an electronic device associated with a user; determining, by the one or more processors, an origin tile based on the origin and a destination tile based on the destination; automatically determining, by the one or more processors, a first region surrounding the origin tile and a second region surrounding the destination tile; aggregating, by the one or more processors, shipping information corresponding to shipments delivered between the first region and the second region;

calculating, by the one or more processors, one or more shipping metrics based on the shipping information; and rendering, on a user interface, the one or more shipping metrics for access by the electronic device.

In a variation of this embodiment, aggregating the shipping information further comprises: accessing, by the one or more processors, a shipping table that includes a plurality of pre-computed shipping metrics for a plurality of pre-defined regions; and retrieving, by the one or more processors, one or more pre-computed shipping metrics from the shipping table, the one or more pre-computed shipping metrics corresponding to the first region and the second region. Further in this variation, calculating the one or more shipping metrics further comprises: calculating, by the one or more processors, the one or more shipping metrics based on the one or more pre-computed shipping metrics corresponding to the first region and the second region.

In another variation of this embodiment, the shipping information corresponds to one or more shipping carriers, and calculating the one or more shipping metrics further comprises: dividing, by the one or more processors, the shipping information into one or more shipping information groups, each shipping information group corresponding to a shipping carrier; calculating, by the one or more processors, one or more shipping carrier metrics for each shipping carrier of the one or more shipping carriers based on the shipping information included in the one or more shipping information groups; and determining, by the one or more processors, one or more preferred carriers based on the one or more shipping carrier metrics.

In yet another variation, the one or more processors aggregate the shipping information from (i) one or more first shipping tiles associated with the first region and (ii) one or more second shipping tiles associated with the second region, and automatically determining the first region surrounding the origin tile and the second region surrounding the destination tile further comprises: automatically filling, by the one or more processors, the first region with the one or more first shipping tiles and the second region with the one or more second shipping tiles. Further in this variation, the one or more first shipping tiles are representative of locations that are at least one of: (i) within 50 kilometers of the origin tile, (ii) within a first same state as the origin tile, or (iii) proximate to a first similar roadway as the origin tile; and the one or more second shipping tiles are representative of locations that are at least one of: (i) within 50 kilometers of the destination tile, (ii) within a second same state as the destination tile, or (iii) proximate to a second similar roadway as the destination tile.

In still another variation, the one or more shipping metrics include at least one of: (i) an estimated cost, (ii) an estimated arrival time, (iii) an estimated travel distance, (iv) an estimated travel time, (v) a total volume of shipments between the first region and the second region, (vi) an on-time performance value for a shipping carrier, or (vii) a booking acceptance rate for the shipping carrier.

In another embodiment, the present invention is a system for analyzing statistics among geographic regions to assess shipping information. The system comprises: a user interface; one or more processors; and one or more memories communicatively coupled with the user interface and the one or more processors. The one or more memories store computer executable instructions thereon that, when executed by the one or more processors, cause the one or more processors to: receive an origin and a destination from an electronic device associated with a user, determine an origin tile based on the origin and a destination tile based on the destination, automatically determine a first region surrounding the origin tile and a second region surrounding the destination tile, aggregate shipping information corresponding to shipments delivered between the first region and the second region, calculate one or more shipping metrics based on the shipping information, and render, on the user interface, the one or more shipping metrics for access by the electronic device.

In a variation of this embodiment, the instructions, when executed, further cause the one or more processors to aggregate the shipping information by: accessing a shipping table that includes a plurality of pre-computed shipping metrics for a plurality of pre-defined regions; and retrieving one or more pre-computed shipping metrics from the shipping table, the one or more pre-computed shipping metrics corresponding to the first region and the second region. Further in this variation, the instructions, when executed, further cause the one or more processors to calculate the one or more shipping metrics by: calculating the one or more shipping metrics based on the one or more pre-computed shipping metrics corresponding to the first region and the second region.

In another variation of this embodiment, the shipping information corresponds to one or more shipping carriers, and wherein the instructions, when executed, further cause the one or more processors to calculate the one or more shipping metrics by: dividing the shipping information into one or more shipping information groups, each shipping information group corresponding to a shipping carrier; calculating one or more shipping carrier metrics for each shipping carrier of the one or more shipping carriers based on the shipping information included in the one or more shipping information groups; and determining one or more preferred carriers based on the one or more shipping carrier metrics.

In yet another variation of this embodiment, the one or more processors aggregate the shipping information from (i) one or more first shipping tiles associated with the first region and (ii) one or more second shipping tiles associated with the second region, and wherein the instructions, when executed, further cause the one or more processors to automatically determine the first region surrounding the origin tile and the second region surrounding the destination tile by: automatically filling the first region with the one or more first shipping tiles and the second region with the one or more second shipping tiles. Further in this variation, the one or more first shipping tiles are representative of locations that are at least one of: (i) within 50 kilometers of the origin tile, (ii) within a first same state as the origin tile, or (iii) proximate to a first similar roadway as the origin tile; and the one or more second shipping tiles are representative of locations that are at least one of: (i) within 50 kilometers of the destination tile, (ii) within a second same state as the destination tile, or (iii) proximate to a second similar roadway as the destination tile.

In still another variation of this embodiment, the one or more shipping metrics include at least one of: (i) an estimated cost, (ii) an estimated arrival time, (iii) an estimated travel distance, (iv) an estimated travel time, (v) a total volume of shipments between the first region and the second region, (vi) an on-time performance value for a shipping carrier, or (vii) a booking acceptance rate for the shipping carrier.

In yet another embodiment, the present invention is a tangible machine-readable medium comprising instructions that, when executed, cause a machine to at least: receive an origin and a destination from an electronic device associated with a user; determine an origin tile based on the origin and a destination tile based on the destination; automatically determine a first region surrounding the origin tile and a second region sur-rounding the destination tile; aggregate shipping information corresponding to shipments delivered between the first region and the second region; calculate one or more shipping metrics based on the shipping information; and render, on a user interface, the one or more shipping metrics for access by the electronic device.

In a variation of this embodiment, the instructions, when executed, further cause the machine to aggregate the shipping information by: accessing a shipping table that includes a plurality of pre-computed shipping metrics for a plurality of pre-defined regions; and retrieving one or more pre-computed shipping metrics from the shipping table, the one or more pre-computed shipping metrics corresponding to the first region and the second region. Further in this variation, the instructions, when executed, further cause the machine to calculate the one or more shipping metrics by: calculating the one or more shipping metrics based on the one or more pre-computed shipping metrics corresponding to the first region and the second region.

In another variation of this embodiment, the shipping information corresponds to one or more shipping carriers, and the instructions, when executed, further cause the machine to calculate the one or more shipping metrics further by: dividing the shipping information into one or more shipping information groups, each shipping information group corresponding to a shipping carrier; calculating one or more shipping carrier metrics for each shipping carrier of the one or more shipping carriers based on the shipping information included in the one or more shipping information groups; and determining one or more preferred carriers based on the one or more shipping carrier metrics.

In yet another variation of this embodiment, the shipping information is aggregated from (i) one or more first shipping tiles associated with the first region and (ii) one or more second shipping tiles associated with the second region, and the instructions, when executed, further cause the machine to automatically determine the first region surrounding the origin tile and the second region surrounding the destination tile by: automatically filling the first region with the one or more first shipping tiles and the second region with the one or more second shipping tiles. Further in this variation, the one or more first shipping tiles are representative of locations that are at least one of: (i) within 50 kilometers of the origin tile, (ii) within a first same state as the origin tile, or (iii) proximate to a first similar roadway as the origin tile; and the one or more second shipping tiles are representative of locations that are at least one of: (i) within 50 kilometers of the destination tile, (ii) within a second same state as the destination tile, or (iii) proximate to a second similar roadway as the destination tile.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example environment in which systems/devices for analyzing statistics among geographic regions to assess shipping information may be implemented, in accordance with embodiments described herein.

FIG. 2 depicts a central logistics server performing actions at several time instances in accordance with instructions executed as part of a dynamic lane aggregation algorithm, and in accordance with embodiments described herein.

FIG. 3A depicts a first example lane, as defined by instructions executed as part of a dynamic lane aggregation algorithm, and in accordance with embodiments described herein.

FIG. 3B depicts a second example lane, as defined by instructions executed as part of a dynamic lane aggregation algorithm, and in accordance with embodiments described herein.

FIG. 3C depicts a third example lane, as defined by instructions executed as part of a dynamic lane aggregation algorithm, and in accordance with embodiments described herein.

FIG. 4 is a flowchart representative of a method for analyzing statistics among geographic regions to assess shipping information, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

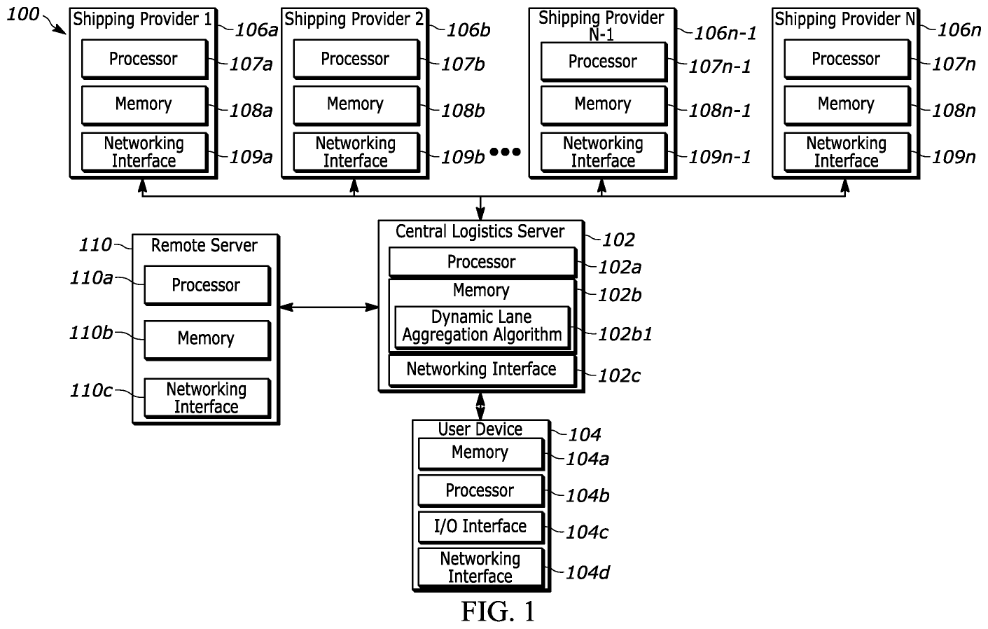

FIG. 1 depicts an example environment 100 in which systems/devices for analyzing statistics among geographic regions to assess shipping information may be implemented, in accordance with embodiments described herein. In the example embodiment of FIG. 1, the example environment 100 includes a central logistics server 102 that is communicatively coupled to a user device 104, a set of shipping provider devices 106a-n, and a remote server 110. Generally speaking, the central logistics server 102, the user device 104, the set of shipping provider devices 106a-n, and/or the remote server 110 may be capable of executing instructions to, for example, implement operations of the example methods described herein, as may be represented by the flowcharts of the drawings that accompany this description. Namely, the central logistics server 102 may be connected to the user device 104, the set of shipping provider devices 106a-n, and/or the remote server 110 across multiple communication channels, and may generally be configured to receive and process information received from the user device 104, the set of shipping provider devices 106a-n, and/or the remote server 110.

Generally speaking, the central logistics server 102 may be configured to transmit and receive data corresponding to shipping providers in order to enable a user to determine an optimal shipping provider for their specific use-case. More specifically, the central logistics server 102 may be configured to receive an origin and destination from a user (e.g., via user device 104), aggregate shipping information associated with various shipping providers (e.g., via shipping provider devices 106a-n), and calculate shipping metrics based on the shipping information. Thereafter, the central logistics server 102 may be configured to transmit the shipping metrics to the user device 104 and render the shipping metrics on a user interface (e.g., via I/O interface 104c) of the device 104 in order to enable the user to view the shipping metrics.

The central logistics server 102 may also include a dynamic lane aggregation algorithm 102b1 in the memory 102b that includes executable instructions that, when executed, may cause the central logistics server 102 to perform one or more of the actions described herein in reference to the methods of the present disclosure. More specifically, the dynamic lane aggregation algorithm 102b1 may instruct the processor 102a to determine an origin tile based on the origin received from a user and a destination tile based on the destination received from a user, automatically determine a first region surrounding the origin tile and a second region surrounding the destination tile, aggregate shipping information corresponding to shipments delivered between the first region and the second region, and/or calculate shipping metrics based on the shipping information. For example, the algorithm 102b1 may instruct the processor 102a to determine the origin tile and the destination tile based on the origin and destination received from the user device 104, determine the first region and the second region, aggregate shipping information from the set of shipping provider devices 106a-n based on the first and second regions, calculate the shipping metrics, and transmit the calculated shipping metrics to the user device 104 for display to the user.

The user device 104 may be any suitable device that a user may use, for example, to execute an application and/or otherwise communicate with the central logistics server 102. In particular, the user device 104 may be or include a mobile phone (e.g., a smartphone), a laptop, a tablet, a smartwatch, smart glasses, and/or any other suitable computing device or combinations thereof that is capable of communicating with the central logistics server 102. The user device 104 includes a memory 104a, one or more processors 104b, an input/output (I/O) interface 104c, and a networking interface 104d. The memory 104a may include an application (not shown), which may generally include executable instructions, that when executed by the one or more processors 104b, cause the user device 104 to perform various actions that enable a user of the user device 104 to receive shipping metrics from the central logistics server 102 corresponding to a lane defined by the user through inputs of the desired origin and destination at the I/O interface 104c.

The I/O interface 104c may include or implement operator interfaces configured to present information to an administrator, user, or operator and/or receive inputs from the administrator, user, or operator. An operator interface may provide a display screen (e.g., via the user device 104) which a user/operator may use to visualize any images, graphics, text, data, features, pixels, and/or other suitable visualizations or information. For example, the user device 104 may comprise, implement, have access to, render, or otherwise expose, at least in part, a graphical user interface (GUI) for displaying images, graphics, text, data, features, pixels, and/or other suitable visualizations or information on the display screen. The I/O interface 104c may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user device 104. According to some embodiments, an administrator or user/operator may access the user device 104 to input origin(s) and destination(s) for determination of shipping metrics, review shipping metrics, make changes, input responses and/or selections, and/or perform other functions.

The set of shipping provider devices 106a-n may generally receive and store shipping information associated with shipments delivered between individual origin and destination pairs. Moreover, each shipping provider device 106a-n may correspond to a particular shipping provider, such that the shipping information received/stored at each device 106a-n may correspond to the specific shipping provider administering the device 106a-n. Each of the set of shipping provider devices 106a-n may include a processor 107a-n, a memory 108a-n, and a networking interface 109a-n.

For example, a first shipping provider may own and/or otherwise administer the shipping provider 1 device 106a, a second shipping provider may own and/or otherwise administer the shipping provider 2 device 106b, a third shipping provider may own and/or otherwise administer the shipping provider N−1 device 106n-1, and a fourth shipping provider may own and/or otherwise administer the shipping provider N device 106n. Consequently, the shipping provider 1 device 106a may receive and store shipping information associated with shipments between various origins/destinations that were performed by the first shipping provider, the shipping provider 2 device 106b may receive and store shipping information associated with shipments between various origins/destinations that were performed by the second shipping provider, the shipping provider N−1 device 106n-1 may receive and store shipping information associated with shipments between various origins/destinations that were performed by the third shipping provider, and the shipping provider N device 106n may receive and store shipping information associated with shipments between various origins/destinations that were performed by the fourth shipping provider. Of course, the central logistics server 102 may be communicatively connected to any suitable number of shipping provider devices 106a-n, such that Nin may be any suitable number.

The remote server 110 may generally be communicatively connected to the central logistics server 102, and may receive and/or transmit data from/to the central logistics server 102. The remote server 110 may also include a processor 110a, a memory 110b, and a networking interface 110c. For example, the central logistics server 102 may receive shipping metrics from the server 102 and may store the shipping metrics in memory 110b. As another example, the central logistics server 102 may transmit shipping information retrieved/accessed from the set of shipping provider devices 106a-n to the remote server 110 for storage in the memory 110b. The remote server 110 may also be configured to execute instructions (via the processor 110a) to, for example, implement operations of the example methods described herein, as may be represented by the flowcharts of the drawings that accompany this description.

More generally, each of the one or more memories 102b, 104a, 108a-n, 110b may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., dynamic lane aggregation algorithm 102b1 and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 102a, 104b, 108a-n, 110a (e.g., working in connection with a respective operating system in the one or more memories 102b, 104a, 108a-n, 110b) to facilitate, implement, or perform the machine readable instructions, methods, processes, elements or limitations, as illustrated, depicted, or described for the various flowcharts, illustrations, diagrams, figures, and/or other disclosure herein.

The memories 102b, 104a, 108a-n, 110b may also store an operating system (OS) (e.g., Microsoft Windows, Linux, Unix, etc.) capable of facilitating the functionalities, apps, methods, or other software as discussed herein. Additionally, or alternatively, an application stored in memory 102b, 104a, 108a-n, 110b may also be stored in an external database (e.g., remote server 110), which is accessible or otherwise communicatively coupled to the central logistics server 102, the user device 104, and/or the set of shipping provider devices 106a-n. For example, at least some of the applications, software components, or APIs may be, include, otherwise be part of, a particular application, where each may be configured to facilitate their various functionalities discussed herein. It should be appreciated that one or more other applications may be envisioned and that are executed by the one or more processors 102a, 104b, 108a-n, 110a.

In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.). Moreover, the one or more memories 102b, 104a, 108a-n, 110b may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein.

The one or more processors 102a, 104b, 108a-n, 110a may be connected to the one or more memories 102b, 104a, 108a-n, 110b via a computer bus responsible for transmitting electronic data, data packets, or otherwise electronic signals to and from the one or more processors 102a, 104b, 108a-n, 110a and one or more memories 102b, 104a, 108a-n, 110b in order to implement or perform the machine readable instructions, methods, processes, elements or limitations, as illustrated, depicted, or described for the various flowcharts, illustrations, diagrams, figures, and/or other disclosure herein.

The one or more processors 102a, 104b, 108a-n, 110a may interface with the one or more memories 102b, 104a, 108a-n, 110b via the computer bus to execute any suitable application, algorithm (e.g., dynamic lane aggregation algorithm 102b1), and/or executable instructions necessary to perform any of the actions associated with the methods of the present disclosure. The one or more processors 102a, 104b, 108a-n, 110a may also interface with the one or more memories 102b, 104a, 108a-n, 110b via the computer bus to create, read, update, delete, or otherwise access or interact with the data stored in the one or more memories 102b, 104a, 108a-n, 110b and/or external databases (e.g., a relational database, such as Oracle, DB2, MySQL, or a NoSQL based database, such as MongoDB). The data stored in the one or more memories 102b, 104a, 108a-n, 110b and/or an external database may include all or part of any of the data or information described herein, including, for example, shipping information, shipping metrics, origin data, destination data, origin/destination tile data, and/or other suitable information or combinations thereof.

The networking interfaces 102c, 104d, 109a-n, 110c may be configured to communicate (e.g., send and receive) data via one or more external/network port(s) to one or more networks or local terminals, as described herein. In some embodiments, the networking interfaces 102c, 104d, 109a-n, 110c may include a client-server platform technology such as ASP.NET, Java J2EE, Ruby on Rails, Node.js, a web service or online API, responsive for receiving and responding to electronic requests. The networking interfaces 102c, 104d, 109a-n, 110c may implement the client-server platform technology that may interact, via the computer bus, with the one or more memories 102b, 104a, 108a-n, 110b (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 102c, 104d, 109a-n, 110c may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a network. In some embodiments, the network (not shown) may comprise a private network or local area network (LAN). Additionally, or alternatively, the network may comprise a public network such as the Internet. In some embodiments, the network may comprise routers, wireless switches, or other such wireless connection points communicating to central logistics server 102 (via the networking interface 102c), the user device 104 (via networking interface 104d), the set of shipping provider devices 106a-n (via the networking interfaces 109a-n), and/or the remote server 110 (via networking interface 110c) via wireless communications based on any one or more of various wireless standards, including by non-limiting example, the BLUETOOTH standard (e.g., BLE), IEEE 802.11a/b/c/g (WIFI), or the like.

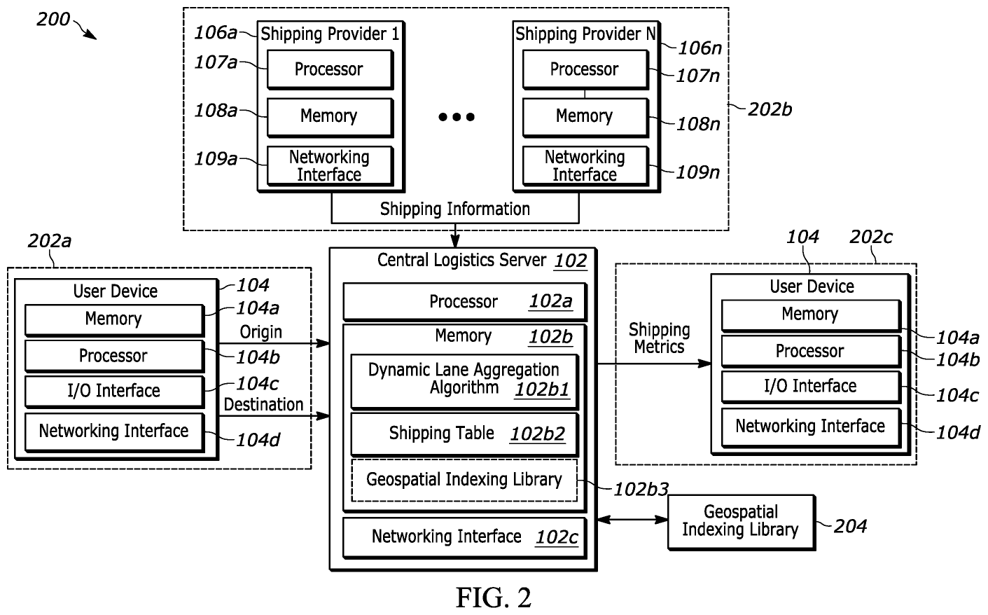

FIG. 2 depicts a central logistics server 102 performing actions at several time instances 202a-c in accordance with instructions executed as part of a dynamic lane aggregation algorithm 102b1, and in accordance with embodiments described herein. Generally speaking, the central logistics server 102 may receive inputs (e.g., an origin and a destination) from the user device 104 at a first time instance 202a, the server 102 may receive shipping information from a set of shipping provider devices 106a-n at a second time instance 202b, and the server 102 may execute the dynamic lane aggregation algorithm 102b1 in order to output shipping metrics for display at the user device 104 at a third time instance 202c.

More specifically, at the first time instance 202a, the central logistics server 102 may receive an origin and a destination from an electronic device associated with a user (e.g., user device 104). A user may desire to search for shipping providers to transport a shipment from the origin to the destination, and may utilize the I/O interface 104c to input the origin and destination for transmission to the central logistics server 102. The origin and the destination input by the user may be and/or include a zip code, a street address, a location name, global positioning system (GPS) coordinates, and/or any other suitable location identifier or combinations thereof.

In certain aspects, the user device 104 and/or the central logistics server 102 (e.g., via the dynamic lane aggregation algorithm 102b1) may automatically complete some/all of the addresses input by user, based on the specificity of the origin and/or the destination input by the user. For example, a user may input an origin of Chicago, Illinois, and the user may also input a destination of Miami, Florida. In this example, the device 104 and/or the server 102 may automatically complete the country (e.g., USA) of the origin address and the destination address because Chicago and Miami are both located in the USA. However, the device 104 and/or the server 102 may not automatically complete the street name/number, building number, zip code, and/or other location identifiers because the user did not specify any particular location in either Chicago or Miami. As another example, the user may input an origin of 123 main Street in Chicago, Illinois, and a destination of 456 A Street in Miami, Florida. In this example, the device 104 and/or the server 102 may automatically retrieve, access, and/or otherwise receive the zip codes corresponding to the origin and destination and may complete the addresses for the origin and the destination by including the respective zip codes.

In any event, based on the origin and destination received from the user device 104, the central logistics server 102 may proceed to determine (e.g., by the one or more processors 102a executing the dynamic lane aggregation algorithm 102b1) an origin tile and a destination tile at the first time instance 202a. The origin tile may be representative of a first geographic area that includes the origin (e.g., a city that includes a particular address within the city), and the destination tile may be representative of a second geographic area that includes the destination. More specifically, the origin tile and the destination tile may correspond to tiles defined in a geospatial indexing library 204 that represents a plurality of locations (e.g., a state, country, etc.) as a grouping of such tiles. For example, the geospatial indexing library 204 may be or include an H3 geospatial indexing library that utilizes a grid system of hexagonal tiles to bucket and/or otherwise aggregate events occurring in a particular area covered by an individual tile as data corresponding to the individual tile, such that the origin tile and the destination tile may be or include tiles from the H3 geospatial indexing library. Thus, when the central logistics server 102 receives the origin and the destination from the user device 104, the server 102 may input the origin and the destination into the dynamic lane aggregation algorithm 102b1, and the algorithm 102b1 may automatically complete the addresses/locations of the origin/destination and reference the geospatial indexing library 204 to determine a tile corresponding to each of the origin and the destination. Further, in certain aspects, the central logistics server 102 may store a geospatial indexing library 102b3 that may be or include the geospatial indexing library 204.

When the dynamic lane aggregation algorithm 102b1 determines the origin tile and the destination tile, the algorithm 102b1 may also automatically determine a first region surrounding the origin tile and a second region surrounding the destination tile based on data corresponding to the origin tile and the destination tile at the first time instance 202a. Namely, the first region and the second region may be representative of geographic areas that encompass and/or otherwise include the first/second geographic areas represented by the origin tile and the destination tile, respectively. As previously mentioned, data associated with the origin tile and the destination tile may be insufficient to provide a user with shipping metrics for each shipping provider and/or may be an insufficient sample size to provide the user with representative shipping metrics for one or more shipping providers. As a result, the dynamic lane aggregation algorithm 102b1 may automatically determine a region surrounding the origin tile and the destination tile based on data corresponding to the origin and destination tiles in order to provide a more robust data set, from which, the algorithm 102b1 may calculate shipping metrics for presentation to the user.

To illustrate, and in certain aspects, the dynamic lane aggregation algorithm 102b1 may instruct the processors 102a to automatically determine the first region surrounding the origin tile by determining one or more first shipping tiles representative of locations that are at least one of: (i) within 50 kilometers of the origin tile, (ii) within a first same state as the origin tile, and/or (iii) proximate to a first similar roadway as the origin tile. Similarly, the algorithm 102b1 may instruct the processors 102a to automatically determine the second region surrounding the destination tile by determining one or more second shipping tiles representative of locations that are at least one of: (i) within 50 kilometers of the destination tile, (ii) within a second same state as the destination tile, and/or (iii) proximate to a second similar roadway as the destination tile.

Simply put, the algorithm 102b1 may instruct the processors 102a to determine the first region and/or the second region based on geographic data corresponding to the origin tile and the destination tile. Of course, in certain instances, the dynamic lane aggregation algorithm 102b1 may instruct the processors 102a to determine the first/second region based on the shipping data corresponding to the origin tile and the destination tile. For example, a user may query the central logistics server 102 for shipping metrics specifically concerning a first shipping provider and a second shipping provider. In this example, the processors 102a may determine that the origin and destination tiles include a large amount of shipping data corresponding to the first shipping provider and a significantly smaller amount of shipping data corresponding to the second shipping provider, but that a pairwise tile set adjacent to the origin and destination tiles includes a substantial amount of shipping data corresponding to the second shipping provider. Accordingly, the processors 102a may determine the first/second regions by, in part, including the pairwise tile set that is adjacent to the origin and destination tiles to provide a more robust data set regarding the two shipping providers of interest to the user. In any event, the dynamic lane aggregation algorithm 102b1 may then instruct the processors 102a to automatically fill the first region surrounding the origin tile with the one or more first shipping tiles, and the algorithm 102b1 may instruct the processors 102a to automatically fill the second region surrounding the origin tile with the one or more second shipping tiles.

At the second time instance 202b, the central logistics server 102 may receive shipping information from the set of shipping provider devices 106a-n. In particular, the dynamic lane aggregation algorithm 102b1 may aggregate shipping information corresponding to shipments delivered between the first region and the second region in response to a user scheduling shipment services from one of the shipping providers represented by the set of shipping provider devices 106a-n. As such, the second time instance 202b may represent a series of shipments, during and after which, the central logistics server 102 may receive shipping information from the respective shipping provider device 106a-n that is performing each respective shipment.

Each shipping provider device 106a-n may transmit the shipping information corresponding to the respective shipment to the central logistics server 102, where the dynamic lane aggregation algorithm 102b1 may store the shipping information in a shipping table 102b2. The dynamic lane aggregation algorithm 102b1 may also associate the shipping information and/or the storage location within the shipping table 102b2 with the map tile to which the shipping information corresponds. The dynamic lane aggregation algorithm 102b1 may then reference the shipping table 102b2 when the algorithm 102b1 determines the origin tile and the destination tile in order to retrieve the shipping information that is associated with the locations represented by the origin tile and the destination tile.

However, in general, the shipping table 102b2 may serve as a storage location for the received shipping information and/or shipping metrics for individual map tiles, pre-defined regions, and/or any other suitable locations or combinations thereof. The dynamic lane aggregation algorithm 102b1 may designate specific locations within the shipping table 102b2 for each shipping provider, and may subdivide those specific locations between shipping information (e.g., received from the shipping provider devices 106a-n) and shipping metrics calculated based on the shipping information.

For example, the central logistics server 102 may receive shipping information from two shipping provider devices 106a and 106n. The first shipping provider device 106a may transmit shipping information to the server 102 corresponding to three shipments recently completed between origin A and destination B, and the second shipping provider device 106n may transmit shipping information to the server 102 corresponding to two shipments recently completed between origin A and destination B. The dynamic lane aggregation algorithm 102b1 may store the shipping information from both devices 106a, 106n into the shipping table 102b2 in specific locations corresponding to the respective shipping providers. Namely, the dynamic lane aggregation algorithm 102b1 may store the shipping information of the three shipments in a first location corresponding to the first shipping provider device 106a, and the algorithm 102b1 may store the shipping information of the two shipments in a second location corresponding to the second shipping provider device 106n.

When the dynamic lane aggregation algorithm 102b1 has instructed the processors 102a to aggregate the shipping information, the algorithm 102b1 may proceed at the third time instance 202c to instruct the processors 102a to calculate and transmit shipping metrics to the user device 104 for viewing by the user. Generally, the algorithm 102b1 may instruct the processors 102a to calculate the shipping metrics by calculating any suitable statistical value corresponding to the aggregated shipping metrics, such as a mean, a median, a mode, a distribution, and/or any other suitable values or combinations thereof corresponding to any suitable data included as part of the aggregated shipping information. For example, the dynamic lane aggregation algorithm 102b1 may instruct the processors 102a to calculate an estimated cost, an estimated arrival time, an estimated travel distance, an estimated travel time, a total volume of shipments between the first region and the second region, an on-time performance value for a shipping carrier, and/or a booking acceptance rate for the shipping carrier.

In the prior example, the dynamic lane aggregation algorithm 102b1 may instruct the processors 102a to calculate and store shipping metrics based on the shipping information received from both devices 106a, 106n into the shipping table 102b2 in specific locations corresponding to the respective shipping providers. Namely, the shipping information corresponding to the three shipments completed by the first shipping provider may indicate, inter alia, that two of the three were completed on-time and that the total travel time from origin A to destination B was one hour, one hour and fifteen minutes, and two hours among the three shipments. Based on this shipping information, the dynamic lane aggregation algorithm 102b1 may instruct the processors 102a to calculate shipping metrics indicating that the first shipping provider completes shipments between origin A and destination B on-time approximately 66% of the time and that the average travel time is approximately one hour and 25 minutes. The dynamic lane aggregation algorithm 102b1 may then instruct the processors 102a to store these calculated shipping metrics in the shipping table 102b2 in a location designated for shipping metrics of the first shipping provider. The dynamic lane aggregation algorithm 102b1 may similarly instruct the processors 102a to calculate shipping metrics for the two shipments completed by the second shipping provider, and may store those calculated shipping metrics in the shipping table 102b2 in a location designated for shipping metrics of the second shipping provider. Thereafter, the algorithm 102b1 may instruct the processors 102a to transmit the calculated shipping metrics corresponding to the first and second shipping providers to the user device 102 for viewing by a user.

However, as part of calculating and transmitting shipping metrics to the user device 104, the dynamic lane aggregation algorithm 102b1 may first check the shipping table 102b2 to retrieve pre-computed shipping metrics that are relevant for the origin/destination tiles (or the surrounding regions), in order to minimize the impact actively calculating such shipping metrics have on processing resources. Generally, performing real-time calculations on large quantities of data can strain processing resources, resulting in latency issues and a degraded user experience. The shipping information obtained from the shipping provider devices 106a-n at the second time instance 202b may include vast amounts of data representing many hundreds/thousands of shipments between each origin/destination pair. Thus, the processor 102a executing the dynamic lane algorithm 102b1 may first execute instructions to retrieve pre-computed shipping metrics from the shipping table 102b2 to determine whether or not such pre-computed shipping metrics are available, and in what quantity. If the processors 102a determine that a suitable amount of pre-computed shipping metrics are available in the shipping table 102b2 that correspond to the origin/destination tiles and surrounding regions, then the processors 102a may further calculate the shipping metrics based on the pre-computed shipping metrics. For example, in certain instances, the processors 102a may statistically average the pre-computed shipping metrics to calculate average values of the pre-computed shipping metrics that may thereafter represent the shipping metrics corresponding to the user's defined lane.

More specifically, the processors 102a may leverage pre-computed shipping metrics that were previously computed for specific tiles (e.g., the origin tile, the destination tile) and/or specific regions (e.g., the first region, the second region). Namely, the dynamic lane aggregation algorithm 102b1 may instruct the processors 102a to calculate and store shipping metrics corresponding to known and/or predetermined regions (e.g., tiles and/or groups of tiles), such that the algorithm 102b1 may instruct the processors 102a to automatically retrieve these shipping metrics in situations where a user inputs an origin and/or a destination that correspond to the predetermined regions in order to preserve processing resources and enhance the overall user experience. These predetermined regions may correspond to and/or otherwise be associated with particular cities, towns, and/or other suitable regions. For example, the dynamic lane aggregation algorithm 102b1 may instruct the processors 102a to automatically associate map tiles that are collectively associated with a major city in order to automatically calculate and store aggregate region shipping metrics corresponding to the major city in the shipping table 102b2.

To illustrate, the central logistics server 102 may receive an origin from the user device 104 corresponding to a first address within a major city, such that the algorithm 102b1 may instruct the processors 102a to determine the origin tile is or corresponds to a tile in the geospatial indexing library 102b3, 204 that includes and/or is otherwise associated with the first address. The algorithm 102b1 may instruct the processors 102a to retrieve shipping information from the shipping table 102b2 that is associated with the origin tile of the geospatial indexing library 102b3, 204 to calculate and store shipping metrics corresponding to the origin tile. The dynamic lane aggregation algorithm 102b1 may also instruct the processors 102a to determine that a second address and a third address are generally associated with the major city based on, e.g., immediate proximity to the first address. Accordingly, the algorithm 102b1 may also instruct the processors 102a to retrieve shipping information from the shipping table 102b2 corresponding to the map tiles associated with the second and third addresses to determine/calculate aggregate shipping metrics for the major city as a more general origin location and to store those aggregate shipping metrics in the shipping table 102b2 for future reference. Further, the algorithm 102b1 may instruct the processors 102a to recognize that the major city has a set of pre-computed shipping metrics stored in the shipping table 102b2, and the processors 102a may retrieve these pre-computed shipping metrics when the processors 102a determine that the origin tile corresponds to the major city. Of course, these examples may also apply to the destination provided by the user.

Thus, in certain aspects, the shipping table 102b2 may include a plurality of pre-computed shipping metrics for a plurality of pre-defined regions (e.g., individual tiles and/or aggregations of tiles). In these aspects, the dynamic lane aggregation algorithm 102b1 may instruct the processors 102a to calculate the one or more shipping metrics by automatically retrieving the pre-computed shipping metrics. More specifically, the processors may automatically retrieve pre-computed shipping metrics corresponding to the first region and the second region. For example, the pre-computed shipping metrics may generally represent shipping metrics for a plurality of shipping providers that completed deliveries and/or other trips between any two locations within the first region and the second region. In any event, the processors 102a may then calculate the one or more shipping metrics for the lane defined by the first and second regions by performing one or more statistical calculations with the aggregated pre-computed shipping metrics for the first and second regions. The first portion of the first region and the second portion of the second region may be any suitable portions of the respective regions, including the entire regions (e.g., the entire first region and/or the entire second region) and/or individual map tiles within the regions (e.g., the origin tile and/or the destination tile).

In any event, when the processors 102a have calculated the shipping metrics, the processors 102a may transmit the shipping metrics to the user device 104 for presentation to the user. The dynamic lane aggregation algorithm 102b1 may include instructions that cause the user device 104 to render the shipping metrics for display at the user device 104 (e.g., via I/O interface 104c). Such display may include a listing of each shipping metric for each shipping provider (e.g., shipping provider 1-N), and may also include a ranked list of shipping providers based on the shipping metrics. For example, a shipping provider 1 may have a lower estimated cost, a higher volume of shipments between the origin and the destination, and a better on-time performance value, and a higher booking acceptance rate than any other shipping provider represented the shipping metrics transmitted to the user device 104. As a result, the shipping provider 1 (and the corresponding shipping metrics) may be listed first in the results displayed to the user as an indication that shipping provider 1 is a preferred/recommended shipping provider for the user's specified origin and destination.

Accordingly, the dynamic lane aggregation algorithm 102b1 may also calculate an overall score for each shipping provider during and/or after calculating the shipping metrics that is to be displayed along with the shipping metrics. This overall score may reflect a recommendation of whether or not the user should use the associated shipping provider to transport their goods from the origin to the destination, and may be based on the relative strength/weakness of the particular shipping provider's shipping metrics relative to the other shipping providers represented in the aggregate shipping information. Using this overall score and/or the listing provided by the algorithm 102b1, the user may make a more informed decision regarding which shipping provider to use when transporting goods from an origin to a destination than was previously possible using conventional techniques.

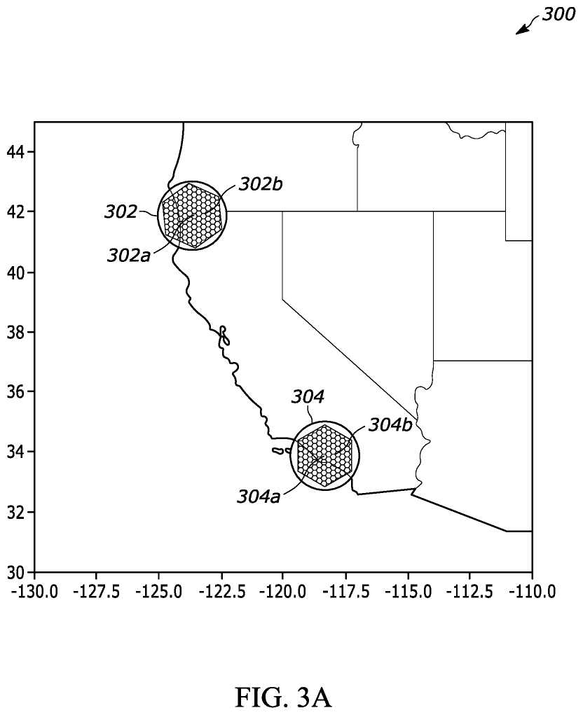

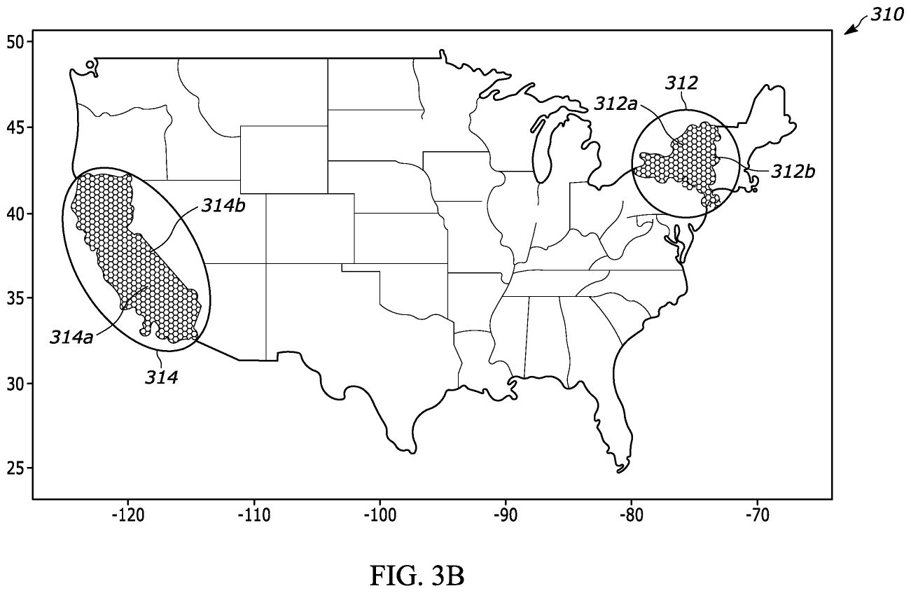

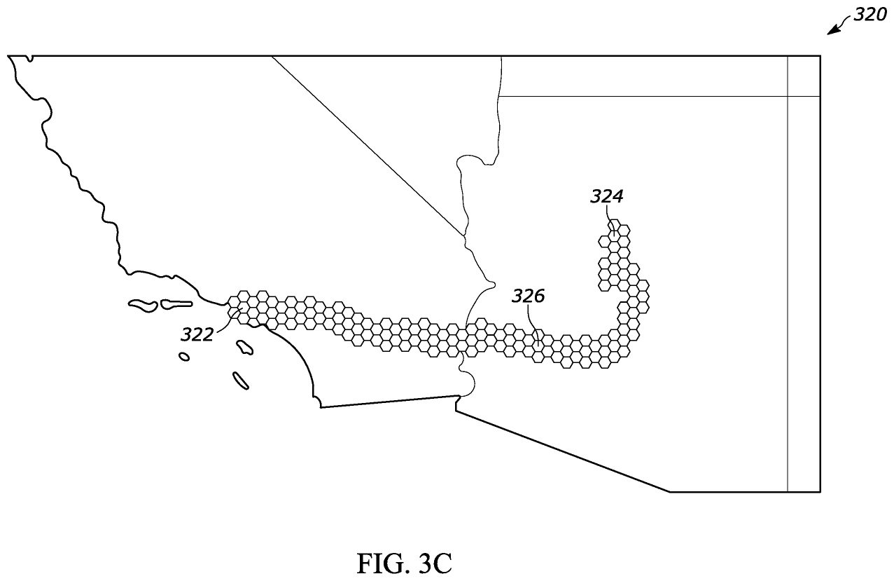

FIG. 3A depicts a first example lane 300, as defined by instructions executed as part of a dynamic lane aggregation algorithm (e.g., dynamic lane aggregation algorithm 102b1), and in accordance with embodiments described herein. The first example lane 300 may generally represent shipments completed on various transportation routes extending between a first region 302 and a second region 304. The first region 302 and the second region 304 may include multiple map tiles 302a, 302b, 304a, 304b that are each representative of geographic regions, over which, shipping information is aggregated, as described herein. In particular, each map tile 302a, 302b, 304a, 304b may represent a geographic region having specified boundaries, such that shipping information with an address (e.g., origin and/or destination) falling within those specified boundaries may be stored in the shipping table (e.g., shipping table 102b2) as being associated with the particular map tile 302a, 302b, 304a, 304b.

For example, the first map tile 302a may be an origin map tile that is representative of and/or otherwise includes an origin location, as input by a user. In this example, the second map tile 302b, may then represent an additional map tile that the processors (e.g., processors 102a) of the central logistics server (e.g., central logistics server 102) may associate with the first map tile 302a in order to construct the first region 302. Similarly, the first map tile 304a may be a destination map tile that is representative of and/or otherwise includes a destination location, as input by a user. The second map tile 304b, may then represent an additional map tile that the processors (e.g., processors 102a) of the central logistics server (e.g., central logistics server 102) may associate with the first map tile 304a in order to construct the second region 304

In the first example lane 300 of FIG. 3A, the first region 302 and the second region 304 may be constructed based on a radius determination, such that all map tiles within a 50 kilometer (km) radius of the origin/destination map tiles/addresses are included in the corresponding region. For example, the first map tile 302a may represent the origin tile of the first example lane 300 and the first map tile 304a may represent the destination tile of the lane 300. The processors 102a may determine the first region 302 and the second region 304 by including each map tile (e.g., second map tiles 302b, 304b) that is within 50 km of the first map tiles 302a, 302b.

Using this radius region construction method, the processors 102a may eliminate issues associated with conventional lane definition techniques. In particular, conventional techniques may encounter unwanted edge artifacts as a result of the shipping metrics resulting from such conventional techniques failing to adequately represent the desired location(s) (e.g., origin, destination). By contrast, the radius definition technique illustrated in FIG. 3A may eliminate such edge artifacts due to the processors 102a dynamically defining the regions 302, 304 around the origin and destination. Further, the radius region construction method illustrated in FIG. 3A offers greater flexibility than conventional techniques by enabling the processors 102a to retrieve shipping information/metrics and/or calculate shipping metrics for neighboring tiles that are included as part of the region (e.g., regions 302, 304). Of course, it should be appreciated that the radius used as part of the radius region construction method may be of any suitable size and in any suitable units (e.g., 10 miles, 50 km, etc.) or combinations thereof.

However, the processors 102a may also construct regions in various other ways based on necessity, as input by a user, and/or as determined by the processors 102a based on various considerations. For example, FIG. 3B depicts a second example lane 310, as defined by instructions executed as part of a dynamic lane aggregation algorithm (e.g., dynamic lane aggregation algorithm 102b1), and in accordance with embodiments described herein. The second example lane 310 may generally represent shipments completed on various transportation routes extending between a first region 312 and a second region 314. The first region 312 and the second region 314 may include multiple map tiles 312a, 312b, 314a, 314b that are each representative of geographic regions, over which, shipping information is aggregated, as described herein. In particular, each map tile 312a, 312b, 314a, 314b may represent a geographic region having specified boundaries, such that shipping information with an address (e.g., origin and/or destination) falling within those specified boundaries may be stored in the shipping table (e.g., shipping table 102b2) as being associated with the particular map tile 312a, 312b, 314a, 314b. For example, the first region 312 may generally represent and/or include all map tiles (e.g., map tiles 312a, 312b) that are associated with a first state (e.g., New York), and the second region 314 may generally represent and/or include all map tiles (e.g., map tiles 314a, 314b) that are associated with a second state (e.g., California).

The first map tile 312a may be an origin map tile that is representative of and/or otherwise includes an origin location, as input by a user. Accordingly, the second map tile 312b, may then represent an additional map tile that the processors (e.g., processors 102a) of the central logistics server (e.g., central logistics server 102) may associate with the first map tile 312a in order to construct the first region 312. Similarly, the first map tile 314a may be a destination map tile that is representative of and/or otherwise includes a destination location, as input by a user. The second map tile 314b, may then represent an additional map tile that the processors (e.g., processors 102a) of the central logistics server (e.g., central logistics server 102) may associate with the first map tile 314a in order to construct the second region 314.

As previously mentioned, in the second example lane 310 of FIG. 3B, the first region 312 and the second region 314 may be constructed based on a state determination, such that all map tiles that are designated in the same state as the origin/destination map tiles/addresses are included in the corresponding region. For example, the first map tile 312a may represent the origin tile of the second example lane 310 and the first map tile 314a may represent the destination tile of the lane 310. The processors 102a may determine the first region 312 and the second region 314 by including each map tile (e.g., second map tiles 312b, 314b) that has a state designation (e.g., as part of the included addresses) that is identical to the first map tiles 312a, 312b. Namely, the processors 102a may analyze the first map tiles 312a, 314a to determine that the map tiles 312a, 314a are representative of locations within New York and California, respectively. Based on this determination, the processors 102a may proceed to construct the regions 312, 314 by including all map tiles (e.g., map tiles 312b, 314b) that are representative of locations within New York and California, respectively.

Using this state region construction method, the processors 102a may eliminate similar issues associated with conventional lane definition techniques as the radius region construction method described in FIG. 3A. In particular, conventional techniques may encounter unwanted edge artifacts as a result of the shipping metrics resulting from such conventional techniques failing to adequately represent the desired location(s) (e.g., origin, destination). By contrast, the state definition technique illustrated in FIG. 3B may eliminate such edge artifacts due to the processors 102a defining the regions 312, 314 around the origin and destination based on state designations. Further, the state region construction method illustrated in FIG. 3B offers greater flexibility than conventional techniques by enabling the processors 102a to retrieve shipping information/metrics and/or calculate shipping metrics for neighboring tiles that are included as part of the region (e.g., regions 312, 314). Of course, it should be appreciated that the state designation may generally apply to any suitable geographic designations (e.g., county, parish, province, territory, administrative region, district, etc.) utilized in any region of the world or combinations thereof.

As another example of a unique lane construction method enabled by the systems and methods of the present disclosure, FIG. 3C depicts a third example lane 320, as defined by instructions executed as part of a dynamic lane aggregation algorithm (e.g., dynamic lane aggregation algorithm 102b1), and in accordance with embodiments described herein. The third example lane 320 may generally represent shipments completed on various transportation routes extending between an origin map tile 322 and a destination map tile 324. The origin map tile 322 and the destination map tile 324 may each represent geographic regions, over which, shipping information is aggregated, as described herein. In particular, each map tile 322, 324, 326 may represent a geographic region having specified boundaries, such that shipping information with an address (e.g., origin and/or destination) falling within those specified boundaries may be stored in the shipping table (e.g., shipping table 102b2) as being associated with the particular map tile 322, 324, 326. For example, each map tile 322, 324, 326 of the third example lane 320 may generally represent locations that are within a particular proximity of and/or are otherwise associated with a specific roadway (e.g., Interstate 10 and Interstate 17) or grouping of roadways.

The first map tile 322 may be an origin map tile that is representative of and/or otherwise includes an origin location, as input by a user. Similarly, the second map tile 324 may be a destination map tile that is representative of and/or otherwise includes a destination location, as input by a user. Accordingly, the third map tile 326 may be an additional map tile that the processors (e.g., processors 102a) of the central logistics server (e.g., central logistics server 102) may associate with the first map tile 322 and/or the second map tile 324 based on the proximity of the location(s) represented by the third map tile 326 to a similar roadway as the first map tile 32 and/or the second map tile 324.

As previously mentioned, the processors 102a may construct the third example lane 320 based on a roadway proximity determination, such that all map tiles (e.g., 322, 324, 326) representing locations within a pre-determined proximity of a similar roadway are included in the lane 320. For example, the first map tile 322 may represent the origin tile of the third example lane 320, the second map tile 324 may represent the destination tile of the lane 320, and the processors 102a may determine (and/or the user may provide as input) a similar roadway (e.g., Interstate 10 and Interstate 17) for one or both of the tiles 322, 324 and/or a proximity threshold (e.g., 10 km) for the similar roadway(s). The processors 102a may then determine that any map tile representing a location within the proximity threshold of the similar roadway should be included as part of the third example lane 320. Namely, the processors 102a may analyze map tiles nearby the similar roadway to determine that map tile 326 and the other illustrated map tiles are representative of locations within 10 km of Interstates 10 and 17 leading to/from the first map tile 322 and the second map tile 324. Based on this determination, the processors 102a may proceed to construct the third example lane 320 by including all map tiles (e.g., map tile 326) representing locations within the proximity threshold of the similar roadway between the first map tile 322 and the second map tile 324.

Using this similar roadway lane construction method, the processors 102a may eliminate similar issues associated with conventional lane definition techniques as the region construction methods described in FIGS. 3A and 3B. In particular, conventional techniques may encounter unwanted edge artifacts as a result of the shipping metrics resulting from such conventional techniques failing to adequately represent the desired location(s) (e.g., origin, destination). By contrast, the similar roadway lane construction method illustrated in FIG. 3C may eliminate such edge artifacts due to the processors 102a defining the lane 320 around the origin and destination based on proximity to similar roadways (e.g., a first roadway, a second roadway, etc.) between the origin and the destination. Further, the similar roadway lane construction method illustrated in FIG. 3C offers greater flexibility than conventional techniques by enabling the processors 102a to retrieve shipping information/metrics and/or calculate shipping metrics for neighboring tiles that are included as part of the lane (e.g., tile 326). Of course, it should be appreciated that the similar roadway may be any suitable roadway/route and/or combination of roadways/routes between an origin and a destination, and that the proximity threshold may be any suitable value.

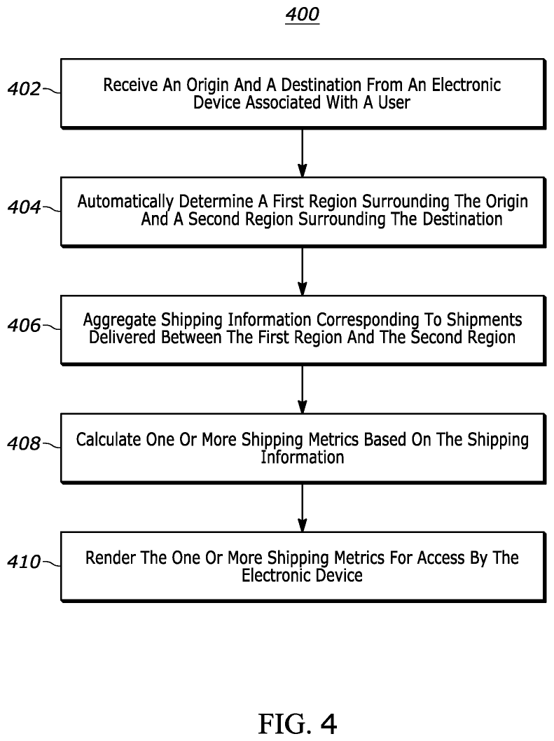

FIG. 4 is a flowchart representative of a method 400 for analyzing statistics among geographic regions to assess shipping information, in accordance with embodiments described herein. Generally, and as described herein, the method 400 for analyzing statistics among geographic regions to assess shipping information may cause the central logistics server 102 to receive an origin and a destination from an electronic device associated with a user, determine regions surrounding the origin and the destination, aggregate shipping information corresponding to the regions, calculate shipping metrics, and render the shipping metrics for access by the electronic device. More specifically, the method 400 enables the central logistics server 102 to consistently and reliably provide relevant shipping logistics data for users by dynamically defining lanes based on aggregated shipping information. It is to be understood that any of the steps of the method 400 may be performed by, for example, the central logistics server 102, and/or any other suitable components or combinations thereof discussed herein.

At block 402, the method 400 includes receiving an origin and a destination from an electronic device associated with a user. In certain aspects, the method 400 may further include determining an origin tile (e.g., first map tile 302a) based on the origin and a destination tile (e.g., first map tile 304a) based on the destination.

At block 404, the method 400 includes automatically determining a first region surrounding the origin tile and a second region surrounding the destination tile. Generally, the processors may automatically determine the first and second region based on data corresponding to the origin tile and the destination tile (e.g., geographic location data, shipping data, etc.). In some aspects, one or more processors (e.g., processors 102a) may aggregate the shipping information from (i) one or more first shipping tiles associated with the first region and (ii) one or more second shipping tiles associated with the second region. In these aspects, automatically determining the first region surrounding the origin tile and the second region surrounding the destination tile may further comprise: automatically filling the first region with the one or more first shipping tiles and the second region with the one or more second shipping tiles.

In certain aspects, the one or more first shipping tiles are representative of locations that are at least one of: (i) within 50 kilometers of the origin tile, (ii) within a first same state as the origin tile, or (iii) proximate to a first similar roadway as the origin tile. Further, the one or more second shipping tiles may be representative of locations that are at least one of: (i) within 50 kilometers of the destination tile, (ii) within a second same state as the destination tile, or (iii) proximate to a second similar roadway as the destination tile.

At block 406, the method 400 includes aggregating shipping information corresponding to shipments delivered between the first region and the second region. The method 400 may further include calculating one or more shipping metrics based on the shipping information (block 408). In certain aspects, the method 400 may also include aggregating the shipping metrics by accessing a shipping table that includes a plurality of pre-computed shipping metrics for a plurality of pre-defined regions; and retrieving one or more pre-computed shipping metrics from the shipping table, the one or more pre-computed shipping metrics corresponding to the first region and the second region. For example, the shipping information may be stored in a shipping table (e.g., shipping table 102b2), and the shipping table may include a plurality of pre-computed shipping metrics for a plurality of pre-defined regions. In these aspects, the method 400 may further include calculating the one or more shipping metrics by calculating the one or more shipping metrics based on the one or more pre-computed shipping metrics corresponding to the first region and the second region.

In certain aspects, the shipping information corresponds to one or more shipping carriers. In these aspects, calculating the one or more shipping metrics may further include dividing the shipping information into one or more shipping information groups. Each shipping information group may correspond to a shipping carrier, and the processors may calculate one or more shipping carrier metrics for each shipping carrier of the one or more shipping carriers based on the shipping information included in the one or more shipping information groups. Further, the method 400 may additionally include determining one or more preferred carriers based on the one or more shipping carrier metrics.

The method 400 may further include rendering, on a user interface (e.g., I/O interface 104c), the one or more shipping metrics for access by the electronic device (block 410). In some aspects, the one or more shipping metrics may include at least one of: (i) an estimated cost, (ii) an estimated arrival time, (iii) an estimated travel distance, (iv) an estimated travel time, (v) a total volume of shipments between the first region and the second region, (vi) an on-time performance value for a shipping carrier, or (vii) a booking acceptance rate for the shipping carrier.

Of course, it is to be appreciated that the actions of the method 500 may be performed in any suitable order and any suitable number of times.

### Additional Considerations

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for analyzing statistics among geographic regions to assess shipping information, the method comprising:
receiving, at one or more processors, an origin and a destination from an electronic device associated with a user;
determining, by the one or more processors, an origin tile representative of a first geographic area that includes the origin and a destination tile representative of a second geographic area that includes the destination;
automatically determining, by the one or more processors, a first region surrounding the origin tile and a second region surrounding the destination tile based on data corresponding to the origin tile and the destination tile;
aggregating, by the one or more processors, shipping information corresponding to shipments delivered between the first region and the second region;
calculating, by the one or more processors, one or more shipping metrics based on the shipping information; and
rendering, on a user interface, the one or more shipping metrics for access by the electronic device.

2. The method of claim 1, wherein aggregating the shipping information further comprises:
accessing, by the one or more processors, a shipping table that includes a plurality of pre-computed shipping metrics for a plurality of pre-defined regions; and
retrieving, by the one or more processors, one or more pre-computed shipping metrics from the shipping table, the one or more pre-computed shipping metrics corresponding to the first region and the second region.

3. The method of claim 2, wherein calculating the one or more shipping metrics further comprises:
calculating, by the one or more processors, the one or more shipping metrics based on the one or more pre-computed shipping metrics corresponding to the first region and the second region.

4. The method of claim 1, wherein the shipping information corresponds to one or more shipping carriers, and calculating the one or more shipping metrics further comprises:
dividing, by the one or more processors, the shipping information into one or more shipping information groups, each shipping information group corresponding to a shipping carrier;
calculating, by the one or more processors, one or more shipping carrier metrics for each shipping carrier of the one or more shipping carriers based on the shipping information included in the one or more shipping information groups; and
determining, by the one or more processors, one or more preferred carriers based on the one or more shipping carrier metrics.

5. The method of claim 1, wherein the one or more processors aggregate the shipping information from (i) one or more first shipping tiles associated with the first region and (ii) one or more second shipping tiles associated with the second region, and automatically determining the first region surrounding the origin tile and the second region surrounding the destination tile further comprises:
automatically filling, by the one or more processors, the first region with the one or more first shipping tiles and the second region with the one or more second shipping tiles.

6. The method of claim 5, wherein:
the one or more first shipping tiles are representative of locations that are at least one of: (i) within 50 kilometers of the origin tile, (ii) within a first same state as the origin tile, or (iii) proximate to a first similar roadway as the origin tile; and
the one or more second shipping tiles are representative of locations that are at least one of: (i) within 50 kilometers of the destination tile, (ii) within a second same state as the destination tile, or (iii) proximate to a second similar roadway as the destination tile.

7. The method of claim 1, wherein the one or more shipping metrics include at least one of: (i) an estimated cost, (ii) an estimated arrival time, (iii) an estimated travel distance, (iv) an estimated travel time, (v) a total volume of shipments between the first region and the second region, (vi) an on-time performance value for a shipping carrier, or (vii) a booking acceptance rate for the shipping carrier.

8. A system for analyzing statistics among geographic regions to assess shipping information, the system comprising:
a user interface;
one or more processors; and
one or more memories communicatively coupled with the user interface and the one or more processors, the one or more memories storing computer executable instructions thereon that, when executed by the one or more processors, cause the one or more processors to:
receive an origin and a destination from an electronic device associated with a user,
determine an origin tile representative of a first geographic area that includes the origin and a destination tile representative of a second geographic area that includes the destination,
automatically determine a first region surrounding the origin tile and a second region surrounding the destination tile based on data corresponding to the origin tile and the destination tile,
aggregate shipping information corresponding to shipments delivered between the first region and the second region,
calculate one or more shipping metrics based on the shipping information, and
render, on the user interface, the one or more shipping metrics for access by the electronic device.

9. The system of claim 8, wherein the instructions, when executed, further cause the one or more processors to aggregate the shipping information by:
accessing a shipping table that includes a plurality of pre-computed shipping metrics for a plurality of pre-defined regions; and
retrieving one or more pre-computed shipping metrics from the shipping table, the one or more pre-computed shipping metrics corresponding to the first region and the second region.

10. The system of claim 9, wherein the instructions, when executed, further cause the one or more processors to calculate the one or more shipping metrics by:
calculating the one or more shipping metrics based on the one or more pre-computed shipping metrics corresponding to the first region and the second region.

11. The system of claim 8, wherein the shipping information corresponds to one or more shipping carriers, and wherein the instructions, when executed, further cause the one or more processors to calculate the one or more shipping metrics by:
dividing the shipping information into one or more shipping information groups, each shipping information group corresponding to a shipping carrier;
calculating one or more shipping carrier metrics for each shipping carrier of the one or more shipping carriers based on the shipping information included in the one or more shipping information groups; and
determining one or more preferred carriers based on the one or more shipping carrier metrics.

12. The system of claim 8, wherein the one or more processors aggregate the shipping information from (i) one or more first shipping tiles associated with the first region and (ii) one or more second shipping tiles associated with the second region, and wherein the instructions, when executed, further cause the one or more processors to automatically determine the first region surrounding the origin tile and the second region surrounding the destination tile by:
automatically filling the first region with the one or more first shipping tiles and the second region with the one or more second shipping tiles.

13. The system of claim 12, wherein
the one or more first shipping tiles are representative of locations that are at least one of: (i) within 50 kilometers of the origin tile, (ii) within a first same state as the origin tile, or (iii) proximate to a first similar roadway as the origin tile; and
the one or more second shipping tiles are representative of locations that are at least one of: (i) within 50 kilometers of the destination tile, (ii) within a second same state as the destination tile, or (iii) proximate to a second similar roadway as the destination tile.

14. The system of claim 8, wherein the one or more shipping metrics include at least one of: (i) an estimated cost, (ii) an estimated arrival time, (iii) an estimated travel distance, (iv) an estimated travel time, (v) a total volume of shipments between the first region and the second region, (vi) an on-time performance value for a shipping carrier, or (vii) a booking acceptance rate for the shipping carrier.

15. A tangible machine-readable medium comprising instructions that, when executed, cause a machine to at least:
receive an origin and a destination from an electronic device associated with a user;
determine an origin tile representative of a first geographic area that includes the origin and a destination tile representative of a second geographic area that includes the destination;
automatically determine a first region surrounding the origin tile and a second region surrounding the destination tile based on data corresponding to the origin tile and the destination tile;
aggregate shipping information corresponding to shipments delivered between the first region and the second region;
calculate one or more shipping metrics based on the shipping information; and
render, on a user interface, the one or more shipping metrics for access by the electronic device.

16. The tangible machine-readable medium of claim 15, wherein the instructions, when executed, further cause the machine to aggregate the shipping information by:
accessing a shipping table that includes a plurality of pre-computed shipping metrics for a plurality of pre-defined regions; and
retrieving one or more pre-computed shipping metrics from the shipping table, the one or more pre-computed shipping metrics corresponding to the first region and the second region.

17. The tangible machine-readable medium of claim 16, wherein the instructions, when executed, further cause the machine to calculate the one or more shipping metrics by:
calculating the one or more shipping metrics based on the one or more pre-computed shipping metrics corresponding to the first region and the second region.

18. The tangible machine-readable medium of claim 15, wherein the shipping information corresponds to one or more shipping carriers, and the instructions, when executed, further cause the machine to calculate the one or more shipping metrics further by:
dividing the shipping information into one or more shipping information groups, each shipping information group corresponding to a shipping carrier;
calculating one or more shipping carrier metrics for each shipping carrier of the one or more shipping carriers based on the shipping information included in the one or more shipping information groups; and
determining one or more preferred carriers based on the one or more shipping carrier metrics.

19. The tangible machine-readable medium of claim 15, wherein the shipping information is aggregated from (i) one or more first shipping tiles associated with the first region and (ii) one or more second shipping tiles associated with the second region, and the instructions, when executed, further cause the machine to automatically determine the first region surrounding the origin tile and the second region surrounding the destination tile by:
automatically filling the first region with the one or more first shipping tiles and the second region with the one or more second shipping tiles.

20. The tangible machine-readable medium of claim 19, wherein
the one or more first shipping tiles are representative of locations that are at least one of: (i) within 50 kilometers of the origin tile, (ii) within a first same state as the origin tile, or (iii) proximate to a first similar roadway as the origin tile; and
the one or more second shipping tiles are representative of locations that are at least one of: (i) within 50 kilometers of the destination tile, (ii) within a second same state as the destination tile, or (iii) proximate to a second similar roadway as the destination tile.
